(19) United States
(12) Patent Application Publication
(10) Pub. No.: US 2004/0073571 A1
(43) Pub. Date: Apr. 15, 2004

(54) Console flight management system and method

(75) Inventors: David Bruce Kumhyr, Austin, TX (US); James Neal Andrews, Austin, TX (US)

Correspondence Address: Duke W. Yee,, Carstens, Yee & Cahoon, LLP, P.O. Box 802334, Dallas, TX, 75380, US

(73) Assignee: International Business Machines Corporation, Armonk, NY (US)

(21) Appl. No.: 10/268,259

(22) Filed: Oct. 10, 2002

(51) Int. Cl. G06F 7/00

(52) U.S. Cl. 707/104.1

(57) ABSTRACT

A console flight management system and method are provided. With the system and method, sensor/instrument signals are obtained from sensors and instruments of the aircraft and are passed through one or more driver interfaces. The driver interfaces act as device drivers for the particular sensors and instruments and convert the signals received into a standardized data format. The sensor/instrument data obtained from the sensor/instrument signals, which has been formatted to the standardized data format, is then provided to a flight management information correlation engine. The flight management information correlation engine obtains correlation rules and correlation configuration data from associated databases and applies the correlation rules and correlation configuration data to the formatted sensor/instrument data. The result is a correlation of the sensor/instrument data that provides meaningful information to a pilot such that the information aides the pilot in the operation of the aircraft based on the current sensor and instrument readings. The output from the application of the correlation rules and correlation configuration data to the sensor/instrument data is then formatted using templates established for different types of portable devices. The formatted output is then sent to an input/output interface which may transmit the output via a wired or wireless connection to the portable device.

### BACKGROUND OF THE INVENTION

1. Technical Field

The present invention is directed to a flight management system. More specifically, the present invention is directed to a flight management system that may be implemented using portable devices and standardized interfaces.

2. Description of Related Art

Regularly scheduled airlines incorporate complex and specialized flight management systems in the flight decks of aircraft to correlate data from multiple sources into coherent information for the management of the progress of the flight. There are many examples of flight management systems, some of which are described in the following U.S. Patents which are hereby incorporated by reference:

U.S. Pat. No. 6,317,659, entitled “Layered Subsystem Architecture for a Flight Management System,” issued to Lindsley et al. on Nov. 13, 2001 describes an aircraft flight management system based on a layered subsystem architecture residing on a computing platform and including an operator interface subsystem, a communications subsystem, a flight management subsystem, and a database management subsystem.

U.S. Pat. No. 6,163,743, entitled “Process and Device for Aiding Aerial Navigation,” issued to Bomans et al. on Dec. 19, 2000 describes a process for aiding aerial navigation using a flight management system which carries out a dialogue with the pilot by means of several interfaces which include at least one display screen.

These systems are costly, specialized to large commercial or military aircraft, and are typically of a specific hardware implementation and thus, are not generalized for use in a plurality of different aircraft. Thus, such systems are not typically available to the average commuter pilot. As a result, the advantages of flight management systems are not readily available to the average pilot.

Thus, it would be beneficial to have a system and method for providing flight management system support to the average pilot in a simplified and less expensive manner than that of known flight management systems.

### SUMMARY OF THE INVENTION

The present invention provides a console flight management system and method in which sensor and instrument signals are obtained from sensors and instruments of the aircraft and are passed through one or more driver interfaces. The driver interfaces act as device drivers for the particular sensors and instruments and convert the signals received into a standardized data format.

The sensor/instrument data obtained from the sensor/instrument signals, which has been formatted to the standardized data format, is then provided to a flight management information correlation engine. The flight management information correlation engine obtains correlation rules and correlation configuration data from associated databases and applies the correlation rules and correlation configuration data to the formatted sensor/instrument data. The result is a correlation of the sensor/instrument data that provides meaningful information to a pilot such that the information aides the pilot in the operation of the aircraft based on the current sensor and instrument readings.

The output from the application of the correlation rules and correlation configuration data to the sensor/instrument data is then formatted using one or more templates obtained from a template database. The templates preferably are established for different types of portable devices that may be used to display the output from the flight management information correlation engine. The templates may further be defined for different combinations of information. The templates used may be selected based on, for example, the type of output device currently coupled to the system, the particular information requested by a user, the currently available information, particular warnings or messages that are to be displayed, and the like.

The formatted output is then sent to an input/output interface. A portable device may be coupled to the output interface through a wired or wireless connection. The formatted output is transmitted via the input/output interface to the output device where it is output for viewing by a pilot or other user. In addition, the system may receive input from the pilot or user via the portable device and the input/output interface.

These and other features and advantages of the present invention will be described in, or will become apparent to those of ordinary skill in the art in view of, the following detailed description of the preferred embodiments.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is an exemplary block diagram of a console flight management system in accordance with the present invention;

FIG. 2 is an exemplary message flow diagram illustrating an exemplary operation of the present invention;

FIG. 3A is an exemplary diagram of an output of the console flight management system of the present invention;

FIG. 3B is another exemplary diagram of an output of the console flight management system of the present invention;

FIG. 3C is a third exemplary diagram of an output of the console flight management system of the present invention; and

FIG. 4 is a flowchart outlining an exemplary operation of the present invention.

### DETAILED DESCRIPTION OF THE PREFERRED EMBODIMENT

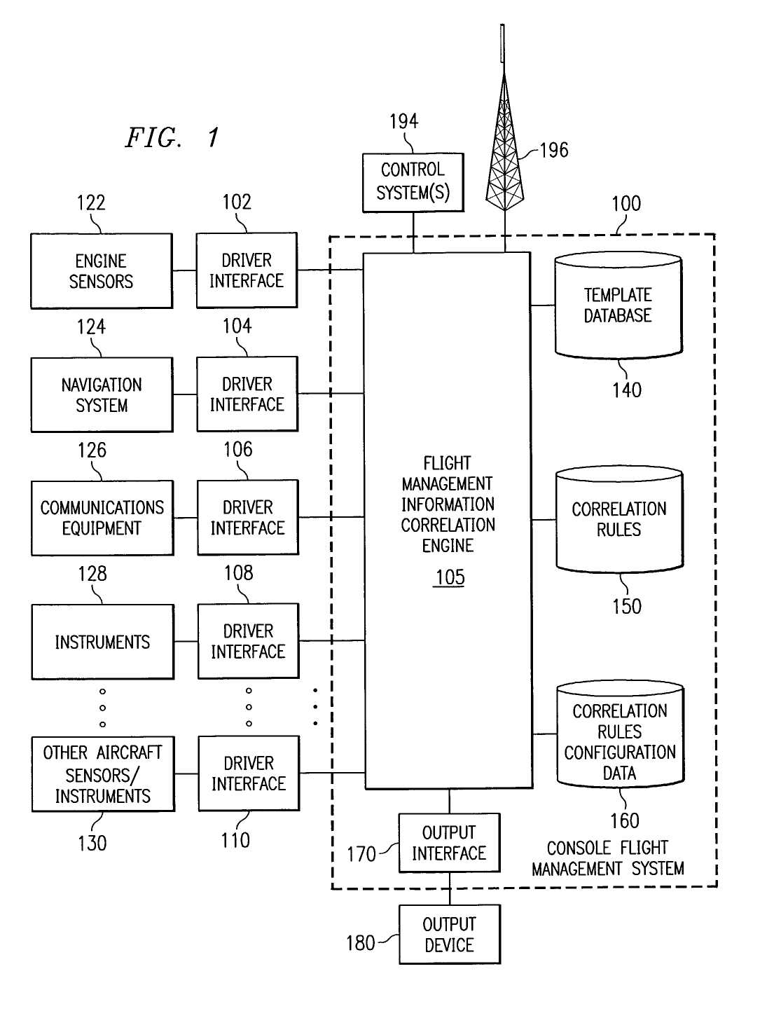

With reference now to the figures, and in particular FIG. 1, the preferred embodiments of the present invention will now be described. FIG. 1 is an exemplary block diagram of a console flight management system in accordance with an embodiment of the present invention. As shown in FIG. 1, the console flight management system 100 includes a flight management information correlation engine 105 and its associated template database 140, correlation rules database 150, correlation rules configuration data 160, input/output (I/O) interface 170, and one or more driver interfaces 102-110. The console flight management system 100 obtains sensor/instrument data from various sensors and instruments 122-130 via the one or more driver interfaces 102-110 and outputs correlated information to an output device 180 for use by a pilot in ascertaining the current situation of the aircraft.

The console flight management system 100 outputs formatted flight management data to output device 180 via the I/O interface 170 and may receive commands from the user via the output device 180 and the I/O interface 170. The output device 180 may be any type of output device capable of outputting flight management information for use by a pilot or other user. The output device 180 may further receive input commands from the user and relay those to the aircraft systems, as discussed hereafter. In a preferred embodiment, the output device 180 is a portable device, such as a PDA, cellular telephone, or the like. Thus, for clarity, the output device 180 will be referred to as a portable device 180 in the following description of the preferred embodiments.

Based on commands received from the user via the portable device 180 and the I/O interface 170, the flight management information correlation engine 105 may issue commands to aircraft control systems 194. In addition, such commands received from the user may cause different information to be correlated and different formatting of information output by the flight management information correlation engine 105 based on the particular templates retrieved from the templates database 140, the correlation rules applied, and/or the correlation configuration information utilized.

The sensors/instruments 122-130 may be any type of sensor or instrument in an aircraft used to monitor various operations of the aircraft. Such sensors and instruments may include those that are either currently found in existing aircraft or sensors and instruments later developed and used to monitor aircraft operations. Examples of such sensors/instruments include engine oil pressure sensors, engine temperature sensors, navigation system sensors (e.g., global positioning system (GPS) sensors), communications equipment sensors, altimeters, air speed sensors, flap position sensors, landing gear position sensors, and the like. Basically, any sensor that may report back a measured value of a particular flight characteristic may be used in conjunction with the present invention.

The sensors/instruments 122-130 are coupled to one or more associated driver interfaces 102-110. The driver interfaces 102-110 serve to convert raw sensor/instrument signals received from the sensors/instruments 122-130 into a standardized format that is useable by the flight management information correlation engine 105. The driver interfaces 102-110 include mechanisms for recognizing the raw sensor/instrument input received and mapping that input to a standardized data signal. This mapping mechanism may be provided as hardware, software, or any combination of hardware and software.

In one exemplary embodiment, the various sensors/instruments 122-130 send analog signals to the driver interfaces 102-110. These analog signals are received by the driver interfaces 102-110 and converted to a RS-232 representation of the analog signals using a mapping algorithm that is either programmed into the driver interface 102-110 or hardwired into the driver interface 102-110. The converted signals are then sent to the flight management information correlation engine 105 over a serial RS-232 connection. As is known in the art, RS-232 is a TIA/EIA standard for serial transmission between computers and peripheral devices (modem, mouse, etc.).

While FIG. 1 illustrates a plurality of driver interfaces, the present invention is not limited to such. Rather, all or a portion of the sensors/instruments 122-130 may be coupled to a single driver interface that handles the formatting of signals received from the sensors/instruments into a standardized format useable by the flight management information correlation engine 105. In addition, while FIG. 1 illustrates the driver interfaces 102-110 as being separate from the flight management information correlation engine 105, the invention is not limited to such. Rather, the driver interfaces 102-110 may be integrated with and be part of the flight management information correlation engine 105 without departing from the spirit and scope of the present invention.

The data may be formatted according to a standardized format template so that the input data may be readily understood by the flight management information correlation engine 105. The standardized data signals, e.g., RS-232 formatted data signals, received from the driver interfaces 102-110 are received in the flight management information correlation engine 105 and stored in a data file which is used to feed the flight management information correlation engine 105. The following is an example of a data file generated by standardized sensor data obtained from the sensors/instruments 122-130 via the interfaces 102-110. The data file in this example is an XML document that feeds the correlation engine 105 for global positioning system (GPS) data.

<!-- ******************************************************************** -->

| <!-- This data file is a representation of the kind of XML document that --> | |
|---|---|
| <!-- will feed the correlation engine for GPS Data. This particular | --> |

| <!-- file contains data for the NMEA format found in most common aviation --> | |
|---|---|
| <!-- GPS receivers | --> |

| <!-- ******************************************************************** --> | |
|---|---|
| <!-- ******************************************************************** --> | |
| <!-- RMB | --> |

| | |
|---|---|
| <!-- | --> |

| | |
|---|---|
| <!-- RMB = Recommended Minimum Navigation Information | --> |

| | |
|---|---|
| <!-- | --> |

| | |
|---|---|
| <!-- $GPRMB,A,x.x,a,c--c,d--d,llll.ll,e,yyyyy.yy,f,g.g,h.h,i.i,j*kk | --> |

| | |
|---|---|
| <!-- | --> |

<!-- The format of this file, enforced by the DTD, assures the FMS that -->
<!-- GPS models that send a NMEA data stream will adhere to this format. -->
<!-- ******************************************************************** -->
<RMB_Packet>

<PacketDataName>

Status

</PacketDataName>
<PacketDataValue>

V

</PacketDataValue>
<PacketDataName>

Crosstrack error

</PacketDataName>
<PacketDataValue>

14.3

</PacketDataValue>
<PacketDataName>

Direction to steer

</PacketDataName>
<PacketDataValue>

L

</PacketDataValue>
<PacketDataName>

Origin waypoint

</PacketDataName>
<PacketDataValue>

6

</PacketDataValue>
<PacketDataName>

Destination waypoint

</PacketDataName>
<PacketDataValue>

17

</PacketDataValue>
<PacketDataName>

Destination waypoint latitude

</PacketDataName>
<PacketDataValue>

0135.01

</PacketDataValue>
<PacketDataName>

N or S

</PacketDataName>
<PacketDataValue>

N

</PacketDataValue>
<PacketDataName>

N or S

</PacketDataName>
<PacketDataValue>

N

</PacketDataValue>
<PacketDataName>

Range to destination

</PacketDataName>
<PacketDataValue>

36

</PacketDataValue>
<PacketDataName>

Bearing to destination

</PacketDataName>
<PacketDataValue>

001

</PacketDataValue>
<PacketDataName>

Destination closing velocity

</PacketDataName>
<PacketDataValue>

150

</PacketDataValue>
<PacketDataName>

Arrival status

</PacketDataName>
<PacketDataValue>

A

</PacketDataValue>
<PacketDataName>

Checksum

<PacketDataName>
<PacketDataValue>

00FA

</PacketDataValue>

</RMB_Packet>

| | |
|---|---|
| <!-- Other NMEA Packet types will include: | --> |

| | |
|---|---|
| <!-- | --> |

| | |
|---|---|
| <!-- RMC = Recommended Minimum Specific GPS/TRANSIT Data | --> |

| | |
|---|---|
| <!-- GGA = Global Positioning System Fix Data | --> |

| | |
|---|---|
| <!-- VTG = Actual track made good and speed over ground | --> |

| | |
|---|---|
| <!-- RMA = Navigation data from present position | --> |

<!-- GSA = GPS receiver operating mode, SVs used for navigation, and DOP values. -->

| | |
|---|---|
| <!-- GSV = Number of SVs in view, PRN numbers, elevation, azimuth & SNR values. | --> |

</NMEAGPS>

The flight management information correlation engine 105 operates on the data file to provide flight management information to the portable device 180 via the input/output interface 170. The flight management information correlation engine 105 operates on the standardized data in the data file by applying correlation rules, retrieved from a correlation rules database 150, to the data signals. The correlation rules correlate the data obtained from the various sensors/instruments to discern meaningful flight management information such as when to switch fuel tanks, airspace alerts when approaching restricted areas, when to lower landing gear, when to change communication channels, and the like.

For example, a correlation rule may be of the type: IF FLIGHT PATH CROSSES TEMPORARY FLIGHT RESTRICTION ZONE, OUTPUT WARNING TO PILOT TO REROUTE. Based on such a rule, the processor of the flight management system may examine sensor and instrument data to compare a flight path with the most recent temporary flight restrictions (TFRs) of which the flight management system is aware (as obtained from notice to airman (NOTAM) messages received by the flight management system).

An example of a correlation rule class in which correlation rules are implemented according to an exemplary embodiment of the present invention is provided below:

| | |
|---|---|
| // | Correlation rule for entering class E airspace. |
| // | The assumption here is that a new update to the FMS_NMEA.xml |
| // | file is being written by the sensor data collection device every |
| // | second. |
| // | This file is periodically read by the correlation engine and the |
| // | data is acted upon by these rules. |
| // | The formatting of the data is done by the IpaqPrintWriter class. |

public class GPSDataCorrelationRuleClassE( ) {

| | |
|---|---|
| // | The document object is a standard XML document type parser class |
| | Document GPS = new Document(FMS_NMEA.xml) |
| // | The formatting of the data is done by the IpaqPrintWriter class. |
| | IpaqPrintWriter ipaqScreen = new IpaqPrintWriter( ); |
| // | Check to see if we are almost ready to land into Class E airspace |

and get the Pilot In Command ready for landing.

If (GPS.doctag(Range to destination) <= 10 ) // if range to

target is 10 miles or less

{

String message = new String(“Entering Class E Airspace /n”)
ipaqScreen(“Title”, message);
String message = new String(“Please begin descending to pattern
altitude./n”
ipaqScreen(“Alert”, message);
if ( GPS.doctag(Destination closing velocity) 100 ) {

String message2 = new String(“Please slow to approach
speed./n”);
IpackScreen(“Warning”,message);

}

}
If ( GPS.doctag(Range to destination) <= 5 ) // if range to

target is 10 miles or less

{

String message = new String(“Landing Check List /n”);
message += “--------------------------------- /n”);
message += “Turn fuel boost pump ON /n”);
message += “Slow to flap extension speed /n”);
message += “Turn fuel selector to FULLEST tank /n”);
message += “Check gear down and green /n”);
message += “Check safety belts for passenger. /n”);
IpackScreen(“CheckList”,message);

}

}

The correlation rules class illustrated above may be used to drive a display, for example, on a portable digital device that runs a Java enabled browser application. For example, portable digital devices that use the WinCE™ operating system are equipped with Internet Explorer™ browser applications which may receive the output from the above correlation rules class and format a display according to the present invention.

The correlation rules are generalized rules that are intended to apply to a plurality of aircraft types. They represent standard rules for providing information to all pilots. Such correlation rules may be stored in permanent memory in the console flight management system 100. Alternatively, such rules may be stored on removable medium to allow for swapping out of correlation rule sets.

The correlation rules operate on the standardized sensor/instrument signal data received by the flight management information correlation engine 105 but may be configured using correlation rules configuration data from the database 160. The correlation rules configuration data is data that is used to configure the correlation rules from a generalized rule to a rule for a specific situation. For example, the correlation rules configuration data may reflect specific characteristics of the particular aircraft in which the console flight management system 100 is installed, the particular flying characteristics or desires of the pilot, and the like. For example, if the pilot likes to receive warnings regarding restricted airspace when the pilot is further away from the restricted airspace than the generalized correlation rules would provide, the correlation rules configuration data may be used to change the range at which the warnings may be provided. The correlation rules configuration data may be entered manually by a user via the portable device 180 or other input mechanism, such as a keyboard (not shown), may be input by way of a wireless transmission received via the transceiver 196, or the like.

In addition, the correlation rules configuration data may be automatically updated based on air traffic control signals received from air traffic control centers via the transceiver 196. For example, if a change in airspace designation is made such that a particular airspace is now restricted, this change in airspace designation may be sent to the console flight management system 100 and stored in the correlation rules configuration data database 160. Thereafter, when the aircraft approaches within a certain range of the newly restricted airspace, the appropriate warnings will be provided via the portable device 180.

Based on the correlation rules, the correlation rules configuration data, and the standardized sensor data, the flight management information correlation engine 105 determines flight management information to be provided to the portable device 180 via the input/output interface 170. This flight management information is formatted in accordance with one or more templates retrieved from the template database 140.

The template database 140 stores templates for formatting flight management information. These templates may be established for different portable devices 180 and/or different combinations of flight management information that are to be provided. For example, if the portable device 180 is a Palm V personal digital assistant, a first template may be used to format the flight management information, whereas if the portable device 180 is a mobile telephone, a second template may be used.

As an example of the selection of templates based on the type of data to be output and the type of device to which the data is to be output, consider the output of engine sensor data to each of a mono-color cellular telephone display, a color display personal digital assistant (PDA) and a color display laptop computer. The output data for each is the same, however, based on the capabilities of the device to which the data is output, certain portions of the data may be removed or displayed differently from the display of the output data on other devices.

For example, for outputting engine data on a mono-color cellular telephone display, a corresponding template may indicate that cylinder head temperature displays and historical trend data should be removed from the primary display and should be moved to a menu option which redraws the information in numerical graphs. For outputting the same information on a color PDA, the corresponding template may indicate that the cylinder head temperature displays and historical trend data should be removed from the primary display and moved to a menu option which draws the information in a color graph. Alternatively, if the same information is output on a color laptop computer, the corresponding template may indicate that all of the engine data is to be displayed in color in the primary display and thus, the cylinder head temperate displays and historical trend data are not moved to a menu option.

As a further example, consider the output of a weather information on each of these devices. For a mono-color cellular telephone display, the corresponding template may indicate that thunderstorm radar data should be displayed in a smaller area of the display than the standard display and have numerical representations of thunderstorm intensity in the smaller display. For a color PDA, the corresponding template may indicate that the thunderstorm display should be provided in a large area that is scrollable with thunderstorm intensity depicted using various colors or color gradations. Similarly, for a laptop computer, a corresponding template may indicate that the weather data be output as a color display of thunderstorm intensity with a large area that is scrollable and which includes indications of lightning strike activity.

Thus, from the above, it is clear that the templates used may vary considerably based on the capabilities of the output device and the particular information being output. The use of such templates with the present invention allows the flight management information correlation engine to be used with any of a number of different portable devices that pilots may use that are relatively inexpensive.

In one exemplary embodiment of the present invention, the portable device 180 is provided with a K Virtual Machine (KVM). The KVM is a version of the Java Virtual Machine for small devices with limited memory. The templates in the template database 140 format flight information using the Extensible Markup Language (XML). The XML flight information data file(s) is then provided to the portable device 180 via the input/output interface 170. The KVM of the portable device 180 then interprets the XML flight information data file(s) and displays the flight information on a display of the portable device 180. Of course, the present invention is not limited to Java or the use of a KVM and other mechanisms may be used in place of the KVM without departing from the spirit and scope of the present invention.

It should be appreciated that rather then merely displaying flight information, the portable device 180 may further provide audible warnings, flashing of indicators, etc. If the portable device is so equipped. The XML flight information may include commands to present the audible warnings, flashing of indicators, and the like.

The portable device 180 may be any type of portable computing device capable of outputting flight information in a visual and/or audible manner. The portable device 180 may be, for example, a personal digital assistant, laptop computing device, mobile telephone, or the like. Moreover, as discussed above, the portable device 180 is only “portable” in preferred embodiments. In other embodiments, the portable device 180 may be replaced with a non-portable device, such as a touch screen display, computer, or the like, without departing from the spirit and scope of the present invention.

The portable device 180 may further include a user interface through which the user may issue commands to the flight management information correlation engine 105. Such commands may include, for example, updating correlation rules configuration data or operating systems of the aircraft. As described further hereafter, for example, the flight information output by the flight management information correlation engine 105 to the portable device 180 may include user operable virtual buttons, input fields, or the like, through which the user may enter commands for the flight management information correlation engine to change flight characteristics of the aircraft.

For example, the flight information output to the portable device may indicate that the landing gear needs to be lowered and provide a virtual button for issuing the command to lower the landing gear. The user may operate the virtual button and thereby send a command to the flight management information correlation engine 105 to lower the landing gear. The flight management information correlation engine 105 may then issue a command instruction to the appropriate control system 194 to lower the landing gear.

The input/output interface 170 may be a wired or wireless interface. That is, the portable device 180 may be coupled to the input/output interface 170 via a cable connection or may communicate in a wireless manner with the input/output interface 170. For example, the input/output interface may be coupled to the portable device 180 via a Universal Serial Bus (USB) connection, a serial connection, a parallel connection, an infrared link (e.g., the input/output interface 170 being an infrared transceiver with a corresponding infrared transceiver being provided in the portable device 180), or the like. If the input/output interface 170 is coupled to the portable device 180 via a wireless link, it is preferable that the particular wireless link used is such that it will not interfere with radio communications or control lines to control systems of the aircraft.

When the portable device 180 is coupled to the input/output interface 170, a handshake operation may be performed in order for the flight management information correlation engine 105 to ascertain the type of portable device 180 that is being used. Information about the portable device 180, and optionally the user, may be stored in a memory (not shown) associated with the flight management information correlation engine 105 for use in obtaining correlation rules configuration data and templates from the databases 140 and 160. This handshake operation may further include security mechanisms for controlling the particular users that are permitted access to the console flight management system 100.

The console flight management system 100 shown in FIG. 1 may be installed in small commuter aircraft. The console flight management system 100 may operate with a user's portable device, such as a personal digital assistant of mobile telephone. Thus, the console flight management system 100 provides a relatively inexpensive mechanism for providing operators of light aircraft with the benefits of a flight management system that has typically only been available to large commercial and military aircraft.

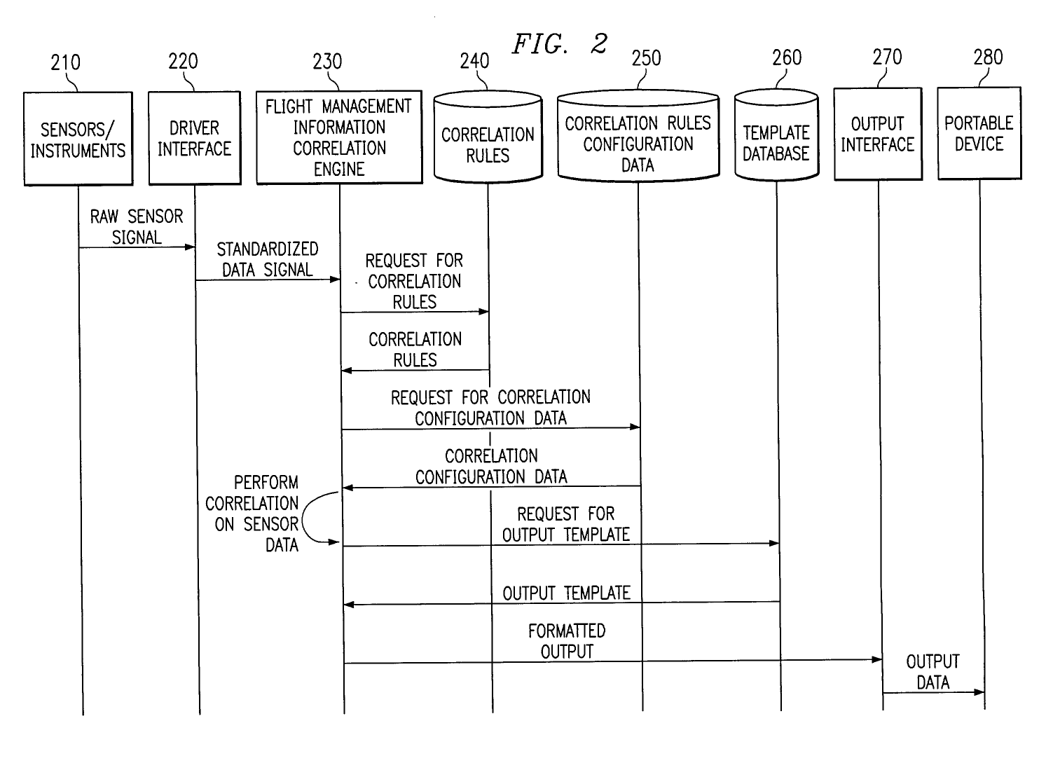

FIG. 2 is an exemplary message flow diagram illustrating an exemplary operation of the present invention. The particular operation shown in FIG. 2 is the operation for outputting flight management information to the portable device. As previously mentioned, other operations including receiving commands from the portable device, updating correlation rules configuration data, and the like are not explicitly illustrated here but are considered straight forward in view of the exemplary operation shown in FIG. 2.

As shown in FIG. 2, raw sensor signals are sent from the sensors/instruments 210 to the driver interface(s) 220. The driver interface(s) 220 convert the raw sensor/instrument signals into standardized data signals, e.g., RS-232 data signals, and sends these standardized data signals to the flight management information correlation engine 230.

The flight management information correlation engine 230 sends a request for correlation rules to the correlation rules database 240. This operation may be done once with the correlation rules being loaded into system memory and used at a subsequent time without requesting the correlation rules from the correlation rules database 240 again. However, when the system is shutdown, the contents of the system memory will be lost and the request will need to be sent to the correlation rules database 240 again.

The flight management information correlation engine 230 receives the correlation rules and sends a request for the correlation rules configuration data from the database 250. This request should be sent either each time a correlation is to be performed or at a periodic basis since this data has a tendency to be dynamically updated and may change from time to time.

The flight management information correlation engine 230 receives the correlation rules configuration data from the database 250 and performs correlation on the sensor data based on the correlation rules as configured by the correlation rules configuration data. The result of this correlation is flight information that is to be output to the portable device 280.

The flight management information correlation engine 230 then sends a request for an output template to the template database 260. The request for the template may include information about the flight information to be output and the particular portable device to which the flight information is to be output. Based on this information, a suitable template may be retrieved and provided to the flight management information correlation engine 230.

The flight management information correlation engine 230 receives the output template and formats the flight management information using the received output template. The formatted output is then sent to the output interface 270 which outputs the data to the portable device 280. The portable device 280 interprets the data and outputs the flight information via a display and/or other output mechanisms.

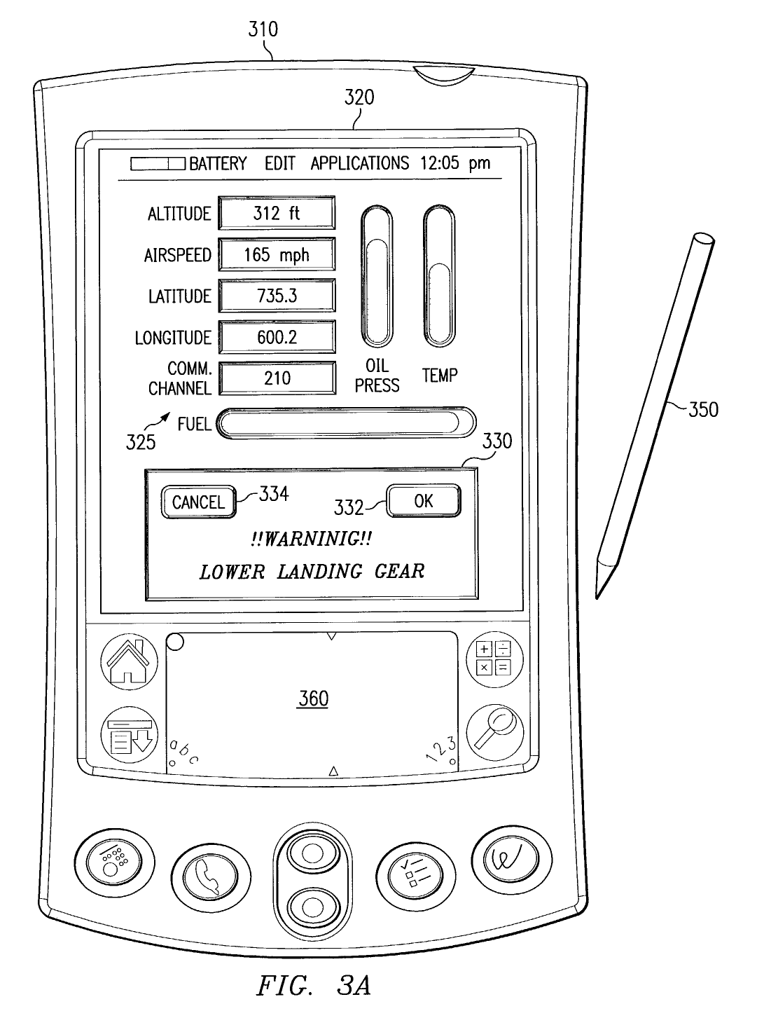

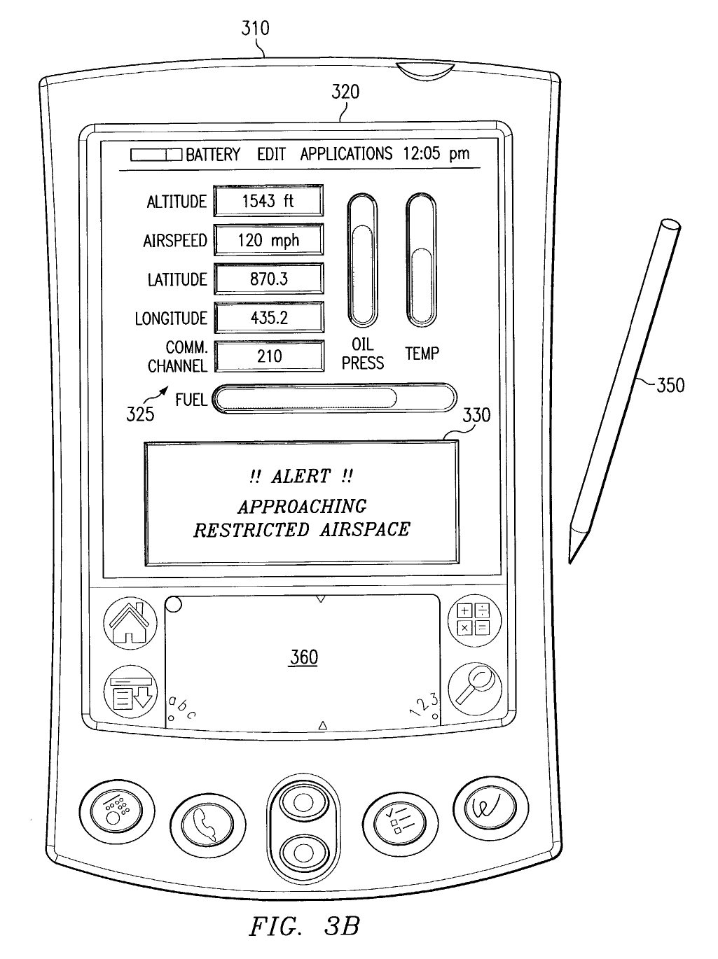

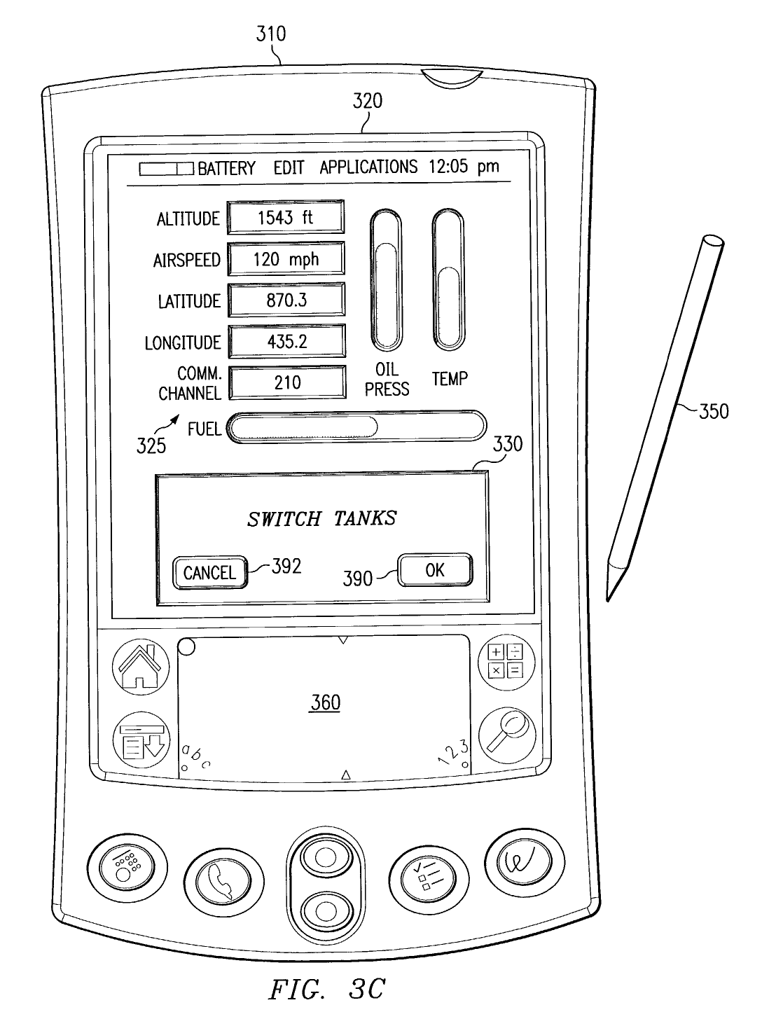

FIGS. 3A-3C are exemplary diagrams of possible flight information output of the console flight management system of the present invention. The particular portable device shown in FIGS. 3A-3C is a personal digital assistant although, as previously stated, the present invention is not limited to such. FIGS. 3A-3C are intended only as illustrations and are not intended to imply any limitation as to the portable device or particular configuration or information that may be displayed on such a portable device.

Referring now to FIG. 3A, as shown the portable device 310 includes a display area 320 and a user interface 360, both of which may manipulated by the user using the stylus 350. The display area 320 includes a first portion 325 where sensor information may be output and a second portion 330 where warnings and other flight information may be displayed.

In the particular example shown in FIG. 3A, a landing gear warning is currently being displayed in the second portion 330 of the display. The landing gear warning further includes a plurality of virtual buttons 332 and 334 which may be operated by the user via the stylus 350. The display 320 of known personal digital assistants is a touch screen and thus, by touching the virtual button area of the display 320 with the stylus 350, the virtual button may be selected.

The virtual button 332 is an acceptance button which, when selected, causes a command to be sent to the flight management information correlation engine to lower the landing gear. The virtual button 334 provides an override command or “cancel” command that allows the user to remove the landing gear warning without sending a command to lower the landing gear. In some instances, such as instances where override may pose a threat to the safety of the aircraft, the override may not be made available for selection by the user.

FIG. 3B is another exemplary diagram of an output of the console flight management system of the present invention. This exemplary diagram illustrates a different warning message that may be output to the user via the portable device. In this particular example, the aircraft has approached within a particular range of restricted airspace. The restricted airspace may be determined based on map information, beacon signals, or the like. The particular range to the restricted airspace may be determined based on the current GPS coordinates of the aircraft and those of the restricted airspace, timing information received from beacon signals, or the like. It should be noted that this warning message does not include virtual buttons that are selectable by the user.

FIG. 3C is a third exemplary diagram of an output of the console flight management system of the present invention. This particular example shows a message that the fuel tanks should be switched. This message may be provided in response to a determination that the remaining fuel is half the maximum and thus, one of the fuel tanks is likely to be empty soon. This flight information further includes virtual buttons 390 and 392 similar to the virtual buttons 332 and 334. However, virtual button 390, when selected, causes a command to be sent to the flight management information correlation engine to switch fuel tanks. Virtual button 392, like virtual button 334, is an override button that allows for removal of the flight information displayed without causing a command to switch the fuel tanks to be sent.

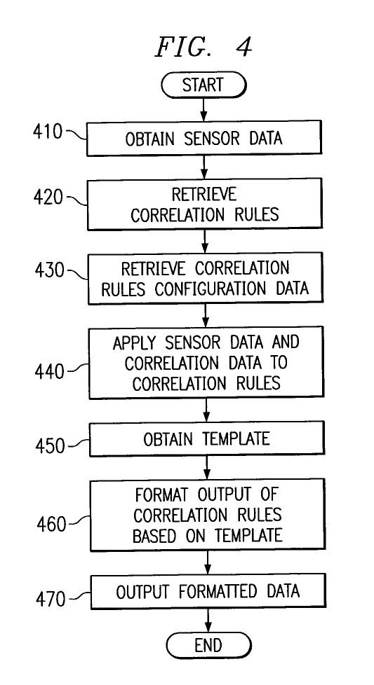

FIG. 4 is a flowchart outlining an exemplary operation of the present invention. As shown in FIG. 4, the operation starts by obtaining sensor data from the sensors/instruments via the driver interface(s) (step 410). Correlation rules are then retrieved from the correlation rules database or from system memory if the correlation rules are already loaded into system memory (step 420). Correlation rules configuration data is retrieved (step 430) and applied to the correlation rules to configure them to the specific situation. The configured correlation rules are then applied to the sensor data (step 440).

A output template is then obtained from the template database based on, for example, the type of portable device to which the flight management information is to be output and/or the particular flight management information to be output (step 450). The flight information is then formatted using the template (step 460) and output to the portable device (step 470).

Thus, the present invention provides a mechanism that accommodates a wide range of data sources, e.g., sensors and instruments, through the use of driver interfaces that conform the signals received from these sources to a standardized format. Furthermore, the present invention provides a system that can be used with a number of different portable devices through the use of a templates for each of these portable devices and the use of a KVM in the portable device. With the present invention, the benefits of flight management systems are now made available to pilots of light aircraft. Furthermore, the present invention significantly increases the safety of light aircraft by reducing the cockpit loading during time critical operations such as landing and takeoff.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A flight management system, comprising:
a correlation engine;
a portable device interface for coupling the correlation engine to a portable device; and
a template database coupled to the correlation engine, wherein the correlation engine correlates data obtained from one or more sensors to generate flight management information, wherein the correlation engine selects a template from the template database for formatting the flight management information based on a type of portable device coupled to the portable device interface, and wherein the flight management information is formatted for output to the portable device based on the selected template.

2. The system of claim 1, wherein the data is obtained from one or more sensors via at least one driver interface, and wherein the at least one driver interface converts signals received from the one or more sensors into a standardized format.

3. The system of claim 2, wherein the standardized format is an RS-232 format.

4. The system of claim 1, wherein the template is selected from a plurality of templates in the template database based on the type of flight information that is to be output.

5. The system of claim 1, wherein the flight information is output in an Extensible Markup Language format.

6. The system of claim 1, wherein the flight information includes at least one user operable element through which the user may issue a command in response to receiving the flight information.

7. The system of claim 1, further comprising:
a correlation rules database coupled to the correlation engine, wherein the correlation engine applies one or more correlation rules from the correlation rules database to the sensor data to generate the flight management information.

8. The system of claim 7, further comprising:
a correlation rules configuration data database coupled to the correlation engine, wherein the correlation rules are configured by the correlation rules configuration data prior to being applied to the sensor data.

9. The system of claim 1, wherein the flight management information is output to the device by way of a wireless connection.

10. The system of claim 1, wherein the device is one of a personal digital assistant and a mobile telephone.

11. A method of providing flight management information to a user of a flight management system, comprising:
obtaining flight data from one or more sensors;
correlating the flight data from the one or more sensors using one or more correlation rules to generate flight management information;
selecting a template for formatting the flight management information to be output on an output device based on a type of the output device; and
outputting the flight management information, formatted using the selected template, to the output device.

12. The method of claim 11, wherein obtaining the flight data from the one or more sensors includes:
converting signals received from the one or more sensors into a standardized format using at least one driver interface.

13. The method of claim 12, wherein the standardized format is an RS-232 format.

14. The method of claim 11, wherein the template is selected from a plurality of templates in a template database based on the type of output device to which the flight information is to be output and a type of flight information that is to be output.

15. The method of claim 11, wherein the flight information is output in an Extensible Markup Language format.

16. The method of claim 11, wherein the flight information includes at least one user operable element through which the user may issue a command in response to receiving the flight information.

17. The method of claim 11, wherein correlating the flight data from the one or more sensors using one or more correlation rules includes using a correlation engine to select and apply one or more correlation rules from a correlation rules database to the flight data.

18. The method of claim 17, wherein correlating the flight data from the one or more sensors using one or more correlation rules further includes:
retrieving correlation rules configuration data from a correlation rules configuration data database; and
configuring the one or more correlation rules based on the retrieved correlation rules configuration data prior to applying the one or more correlation rules to the flight data.

19. The method of claim 11, wherein the flight management information is output to the output device by way of a wireless connection.

20. The method of claim 11, wherein the output device is a portable device.

21. The method of claim 11, wherein the output device is one of a personal digital assistant and a mobile telephone.

22. A computer program product in a computer readable medium for providing flight management information to a user of a flight management system, comprising:
first instructions for obtaining flight data from one or more sensors;
second instructions for correlating the flight data from the one or more sensors using one or more correlation rules to generate flight management information;
third instructions for selecting a template for formatting the flight management information to be output on an output device based on a type of the output device; and
fourth instructions for outputting the flight management information, formatted using the selected template, to the output device.
